(19) United States
(12) Patent Application Publication
(10) Pub. No.: US 2015/0192459 A1
(43) Pub. Date: Jul. 9, 2015

(54) EXTREME ULTRA-VIOLET (EUV) INSPECTION SYSTEMS

(71) Applicant: KLA-Tencor Corporation, Milpitas, CA (US)

(72) Inventor: Damon F. Kvamme, Los Gatos, CA (US)

(73) Assignee: KLA-Tencor Corporation, Milpitas, CA (US)

(21) Appl. No.: 14/589,902

(22) Filed: Jan. 5, 2015

Related U.S. Application Data
(60) Provisional application No. 61/924,839, filed on Jan. 8, 2014.

(51) Int. Cl. G01J 1/04; G01N 21/55

(52) U.S. Cl. CPC G01J 1/0411; G01N 21/55; G01N 2201/0636

(57) ABSTRACT

Disclosed are methods and apparatus for reflecting, towards a sensor, extreme ultra-violet (EUV) light that is reflected from a target substrate. The system includes a first mirror arranged to receive and reflect the EUV light that is reflected from the target substrate, a second mirror arranged to receive and reflect the EUV light that is reflected by the first mirror, a third mirror arranged to receive and reflect the EUV light that is reflected by the second mirror, and a fourth mirror arranged to receive and reflect the EUV light that is reflected by the third mirror. The first mirror has an aspherical surface. The second, third, and fourth mirrors each have a spherical surface.

### CROSS-REFERENCE TO RELATED APPLICATION

This application claims the benefit of prior applications U.S. Provisional Application No. 61/924,839, filed 8 Jan. 2014 by Damon Kvamme, which application is herein incorporated by reference in its entirety for all purposes.

### TECHNICAL FIELD OF THE INVENTION

The invention generally relates to the field of reticle inspection. More particularly the present invention relates to apparatus and techniques for inspecting extreme-ultraviolet (EUV) reticles.

### BACKGROUND

Generally, the industry of semiconductor manufacturing involves highly complex techniques for fabricating integrating circuits using semiconductor materials which are layered and patterned onto a substrate, such as silicon. An integrated circuit is typically fabricated from a plurality of reticles. Generation of reticles and subsequent optical inspection of such reticles have become standard steps in the production of semiconductors. Initially, circuit designers provide circuit pattern data, which describes a particular integrated circuit (IC) design, to a reticle production system, or reticle writer.

Due to the large scale of circuit integration and the decreasing size of semiconductor devices, the reticles and fabricated devices have become increasingly sensitive to defects. That is, defects which cause faults in the device are becoming increasingly smaller. The device can generally be required to be fault free prior to shipment to the end users or customers.

The conventional apparatus in the market for photomask inspection generally employ ultra-violet (UV) light with wavelengths at or above 193 nanometers (nm). This is suitable for masks designed for use in lithography based on 193 nm light. To improve further the printing of minimum feature sizes, next generation lithographic equipment is now designed for operation in the neighborhood of 13.5 nm. Accordingly, patterned masks designed for operation near 13 nm need to be inspected. Such masks are reflective, having a patterned absorber layer over a resonantly-reflecting substrate (such as an EUV multilayer that includes 40 pairs of MoSi with a 7 nm period). There is a need for inspection techniques and apparatus for inspecting EUV reticles, as well as other types of semiconductor samples.

### SUMMARY

The following presents a simplified summary of the disclosure in order to provide a basic understanding of certain embodiments of the invention. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

An apparatus for inspecting a target substrate using extreme ultra-violet (EUV) light is disclosed. The apparatus includes an illumination source for generating EUV light that illuminates a target substrate, and objective optics for receiving and reflecting EUV light that is reflected from the target substrate. The apparatus further includes a sensor for detecting EUV light which is reflected by the objective optics. The objective optics has a first mirror arranged to receive and reflect EUV light that is reflected from the target substrate, a second mirror arranged to receive and reflect EUV light that is reflected by the first mirror, a third mirror arranged to receive and reflect EUV light that is reflected by the second mirror, and a fourth mirror arranged to receive and reflect EUV light that is reflected by the third mirror. The first mirror has an aspherical surface. The second, third, and fourth mirrors each has a spherical surface.

In a specific implementation, the target substrate is an EUV photolithography mask. In a specific aspect, the first and fourth mirrors each have a size that is equal to or greater than about 200 mm, and the second and third mirrors each have a size that is less than or equal to about 50 mm. In another aspect, the second mirror partially obscures the first mirror from EUV light that is reflected from the target substrate, and the first mirror includes an opening through which EUV light that is reflected from the second mirror passes and is received by the third mirror. In another specific implementation, a numerical aperture (NA) of the objective optics is equal to or less than 0.20. For example, the numerical aperture (NA) of the objective optics is between about 0.14 and 0.18. In another example, a magnification of the objective optics has a range between about 300× and 1000×.

In another embodiment, a field of view of the objective optics is at least 10,000 square microns. For example, the field of view of the objective optics is at least 100,000 square microns. In another implementation, the objective optics are associated with a wavefront error that is less than or equal to about 100 milliwaves. In a further aspect, the objective optics are associated with a wavefront error that is less than or equal to about 20 milliwaves. In yet a further aspect, the objective optics are associated with a target blur of an image of an object of the target substrate that is less than a quarter of a diffraction limited point spread function. In one embodiment, the objective optics has a working distance that is at least 100 mm. In another aspect, the objective optics is sized to have a total track distance from the target substrate to the sensor that is less than about 1.5 m.

In an alternative embodiment, the invention pertains to objective optics system for reflecting extreme ultra-violet (EUV) light that is reflected from a target substrate. The system includes a first mirror arranged to receive and reflect EUV light that is reflected from the target substrate, a second mirror arranged to receive and reflect EUV light that is reflected by the first mirror, a third mirror arranged to receive and reflect EUV light that is reflected by the second mirror, and a fourth mirror arranged to receive and reflect EUV light that is reflected by the third mirror. The first mirror has an aspherical surface. The second, third, and fourth mirrors each have a spherical surface. In specific aspects, the objective optics system has one or more of the above-described implementation features.

In another embodiment, the invention pertains to a method of reflecting towards a sensor extreme-ultraviolet (EUV) light that is reflected from an EUV reticle. A first aspherical mirror receives and reflects EUV light that is reflected from the EUV reticle. A second spherical mirror receives and reflects EUV light that is reflected from the first aspherical mirror. A third spherical mirror receives and reflects EUV light that is reflected from the second spherical mirror. A fourth spherical mirror receives and reflects EUV light that is reflected from the third spherical mirror towards the sensor.

These and other aspects of the invention are described further below with reference to the figures.

### BRIEF DESCRIPTION OF THE DRAWINGS

FIG. 1 is a diagrammatic representation of a reflective imaging apparatus in accordance with one embodiment of the present invention.

FIG. 2 is an optical ray diagram of a mirror distribution for the objective optics of FIG. 1 in accordance with a first embodiment of the invention.

FIG. 3 is an optical ray diagram of a mirror distribution for the objective optics of FIG. 1 in accordance with a second embodiment of the invention.

FIG. 4 is a flow chart illustrating a procedure for reflecting EUV light from an EUV reticle towards a sensor in accordance with one embodiment of the present invention.

FIG. 5 is an optical ray diagram of a mirror distribution for the objective optics of FIG. 1 in accordance with a third embodiment of the invention.

### DETAILED DESCRIPTION OF EXAMPLE EMBODIMENTS

In the following description, numerous specific details are set forth in order to provide a thorough understanding of the present invention. The present invention may be practiced without some or all of these specific details. In other instances, well known component or process operations have not been described in detail to not unnecessarily obscure the present invention. While the invention will be described in conjunction with the specific embodiments, it will be understood that it is not intended to limit the invention to the embodiments.

Some EUV microscope objectives (having multilayer-coated mirrors), which are designed for defect or pattern review applications with operation in the neighborhood of 13 nm wavelength of light, are based on a four aspheric mirror design. Aspheric surfaces can be difficult and expensive to manufacture and test since they require more process steps than spherical mirrors, which increase manufacturing costs. Additionally, an objective for imaging EUV light typically includes small mirrors that have short base radii of curvature, which are currently not available from manufactured lens sources. For EUV optics, it can also be difficult to achieve the desired aspheric design and minimize the roughness. Finally, systems that utilize a high NA optical design and critical sampling at the sensor lead to a very high magnification system. As such, more sensors are required in the image plane to cover the large object plane for a high through system.

Certain embodiments of the present invention are based on a lower magnification, which is driven by lower numerical aperture (NA) specification, in addition to a sub-Nyquist sampling rate at the sensor. The resulting optical designs have fewer asphereic mirrors, especially the smaller mirrors, and a shorter track length. In a specific implementation, the aspheres are eliminated for the very small mirrors in the objective system. Spherical, small mirrors are more easily realized, as compared to aspheric small mirrors. Certain embodiments of the present invention also can incorporate aspheric, larger mirrors, which are also readily available.

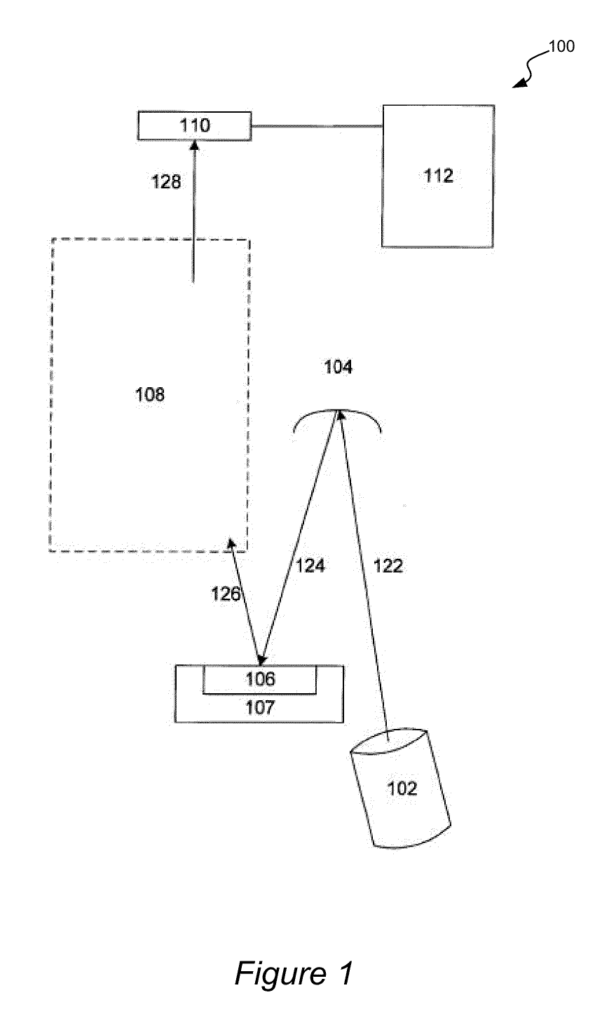

FIG. 1 is a schematic diagram of a reflective imaging apparatus in accordance with an embodiment of the invention. The apparatus 100 includes an EUV illumination source 102, an illumination mirror (or lens system) 104, a target substrate 106, a substrate holder 107, objective optics 108, a sensor (detector) 110, and a data processing system 112.

The EUV illumination source 102 may comprise, for example, a laser-induced plasma source, which outputs an EUV light beam 122. In one embodiment, the EUV light is at a wavelength of 13.5 nm. The illumination mirror 104 (or lens system) reflects and directs the EUV light such that the beam 124 illuminates the target substrate 106. In one embodiment of the invention, the target substrate 106 is an EUV mask being inspection. The target substrate 106 may be scanned under the beam 124 by controllably translating the substrate holder 107 so that the field of view of the imaging apparatus covers regions on the substrate to be inspected.

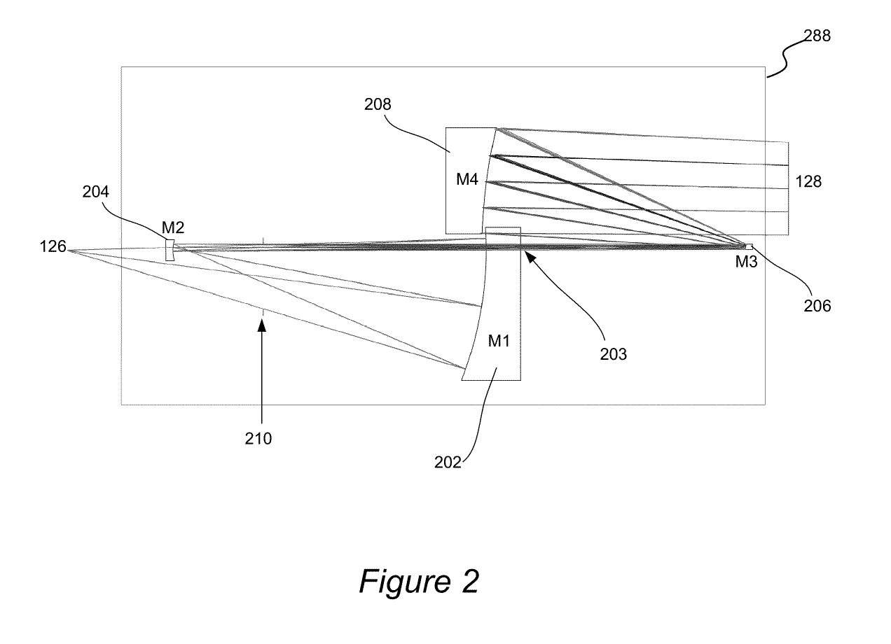

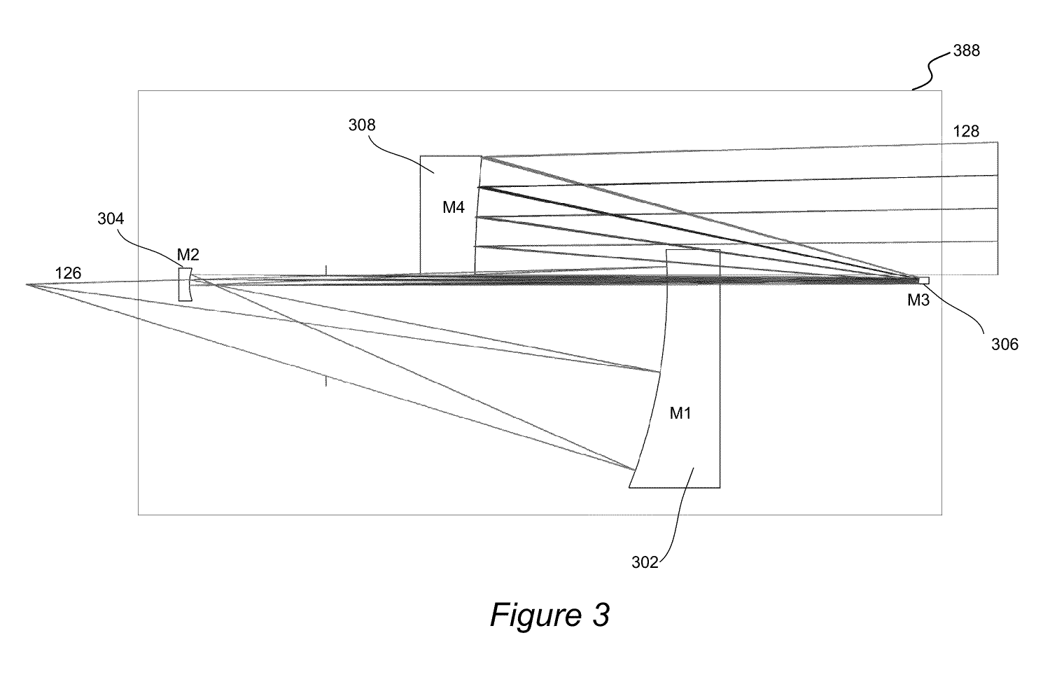

Patterned light 126 is reflected from the target substrate 106 to the reflective objective optics 108. Certain embodiments of the objective optics 108 are described in detail below in relation to FIGS. 2 and 3.

The objective optics 108 outputs a projection 128 of the patterned light onto the sensor 110. Suitable sensors include charged coupled devices (CCD), CCD arrays, time delay integration (TDI) sensors, TDI sensor arrays, photomultiplier tubes (PMT), and other sensors.

The signals captured by the sensor 110 can be processed by a data processing system 112 or, more generally, by a signal processing device, which may include an analog-to-digital converter configured to convert analog signals from the sensor 110 into digital signals for processing. The data processing system 112 may be configured to analyze intensity, phase, and/or other characteristics of the sensed light beam. The data processing system 112 may be configured (e.g., with programming instructions) to provide a user interface (e.g., on a computer screen) for displaying resultant test images and other inspection characteristics. The data processing system 112 may also include one or more input devices (e.g., a keyboard, mouse, joystick) for providing user input, such as changing detection threshold. In certain embodiments, the data processing system 112 can also be configured to carry out inspection techniques. The data processing system 112 typically has one or more processors coupled to input/output ports, and one or more memories via appropriate buses or other communication mechanisms.

In accordance with one embodiment, the data processing system 112 may process and analyze the detected data for pattern inspection and defect detection. For example the processing system 112 may be configured to perform the following operations: producing test light intensity images of a sample that include a test transmitted image and/or a test reflected image and analyzing the test light intensity images based on a reference image (from an imaged sample or from a design database) to identify defects.

Because such information and program instructions may be implemented on a specially configured computer system, such a system includes program instructions/computer code for performing various operations described herein that can be stored on a computer readable media. Examples of machine-readable media include, but are not limited to, magnetic media such as hard disks, floppy disks, and magnetic tape; optical media such as CD-ROM disks; magneto-optical media such as optical disks; and hardware devices that are specially configured to store and perform program instructions, such as read-only memory devices (ROM) and random access memory (RAM).

Examples of program instructions include both machine code, such as produced by a compiler, and files containing higher level code that may be executed by the computer using an interpreter.

FIG. 2 is an optical ray diagram of a mirror distribution for the objective optics 288 in accordance with a first embodiment of the invention. In this embodiment, M1, M2, M3, and M4 mirrors (202, 204, 206, and 208) are arranged such that the patterned light 126 reflects from the M1, M2, M3, and M4 mirrors (202, 204, 206, and 208, respectively) in that order. In this arrangement, the M1 mirror 202 is concave, the M2 mirror 204 is concave, the M3 mirror 206 is convex, the M4 mirror 208 is concave. Hence, the mirrors are, in order: concave; concave; convex; and concave.

An optical prescription for the objective optics 288 in FIG. 2 is provided below in the following Table 1.

TABLE 1
First Embodiment

| Surface Description | | | | Thickness | Aperture Description | | | |
|---|---|---|---|---|---|---|---|---|
| Elt. | Radius | | | or | Dimension | | | |
| No. | X | Y | Shape | Separation | X | Y | Shape | Mat'l. |
| Object | Inf. | | FLT | 0.0000 | | | | |
| | | | | 282.9748 | | | | |
| | | | | 322.0335 | 91.734 | | CIR | (Stop) |
| 1 | −502.164 | CC | A-1 | −452.068 | 200 | 200 | CIR | REFL |
| 2 | 45.739 | CC | SPH | 827.4414 | 20 | 20 | CIR | REFL |
| 3 | 42.291 | CX | SPH | −382.9692 | 22 | 22 | CIR | REFL |
| 4 | 743.997 | CC | SPH | 445.4936 | 210 | 200 | RECT | REFL |
| | | | | 0.0000 | | | | |

| | | |
|---|---|---|
| IMAGE | Inf. | FLT |

The first embodiment also has the following characteristics:

| Field size | 400 μm × 300 μm | |
|---|---|---|
| Field offset | 230 | μm |
| NA | 0.16 | |
| Aperture decenter | −45 | mm |

For the above table, it is noted that a positive radius indicates that the center of curvature is to the right, while a negative radius indicates that the center of curvature is to the left (e.g., towards the object). The dimensions are given in millimeters, and the thickness is the axial distance to the next surface. The image diameter shown above is a paraxial value, instead of a ray traced value.

In certain objective system embodiments described herein, at least one of the mirrors is aspherical (i.e., the M1 mirror of FIG. 2). The form of an aspheric surface can be represented by the following equation:

$$x = \frac{{cr}^{2}}{1 + \sqrt{1 - ( 1 + k ) {c}^{2} {r}^{2}}} + {Ar}^{4} + {Br}^{6} + {Cr}^{8} + {Dr}^{10} + {Er}^{10} + {Fr}^{12} + {Gr}^{16} + {Hr}^{18} + {Jr}^{20}$$

where:
z is the sag of the surface parallel to the z-axis; c is the curvature at the pole of the surface (CUY); and k is the conic constant (K).
A, B, C, D, E, F, G, H, and J are the 4^{th}, 6^{th}, 8^{th}, 10^{th}, 12^{th}, 14^{th}, 16^{th}, 18^{th}, and 20^{th} order are the deformation coefficients, respectively.
r is the radial distance=\sqrt{x²+y²}.

In FIG. 2, the M1 mirror 202 has an aspherical surface, while the other M2˜M4 mirrors have spherical surfaces. That is, some objective embodiments of the present invention include only a single aspherical mirror. The following values may be used for the aspheric constants of this M1 mirror 202:
c=−0.199138×10⁻²
k=0.0000000
A=3.90210×10⁻¹¹
B=1.51375×10⁻¹⁶
C=6.10398×10⁻²²
D=−1.39939×10⁻²⁷
E=8.75957×10⁻³²
F=−6.66078×10⁻³⁷
G=0.00000
H=0.00000
J=0.00000

It is noted that it is easier to manufacture a larger mirror with aspherical surfaces. In contrast, the smaller mirrors are preferably designed to have a spherical surface so that it is more readily available from lens sources. For instance, it is contemplated that one embodiment may include only two spherical surface mirrors (e.g., M1 and M4) and two aspherical mirrors (e.g., M2 and M3). In another embodiment, at least one of the middle mirrors M2 or M3 has a spherical surface although not preferred since such mirrors tend to be smaller.

A small mirror is generally defined as having a size or diameter that is less than about 50 mm or, more specifically, less than 15 mm (e.g., on the side that is receiving the light. In contrast, large mirrors that can be easily made with an aspherical surface include mirrors having a size or diameter that is equal to or higher than about 200 mm (on the side that is receiving the light).

As shown, the second mirror 204 also partially obscures the M1 mirror 202 from the patterned light 126. In other words, part of the area of the M1 mirror 202 is blocked by the M2 mirror 204 from receiving the light 126 reflected from the target substrate 106. Furthermore, an opening 203 in the M1 mirror 202 is used to let the light reflected by the M2 mirror 204 pass through to reach the M3 mirror 206, which reflects such light towards the M4 mirror 408, which reflects the light towards the sensor 110. The system 100 also includes a stop 210 positioned between M1 mirror 202 and M2 mirror 204.

The NA specification can be determined by the sensitivity requirements for a particular lithographic node. In certain embodiments, the NA for the objective optics is lower or equal to 0.20, which is suitable for single-exposure EUV lithography (EUVL) down to 13-15 nm Half-Pitch (HP) and double-exposure EUVL down to 10-12 nm HP by way of examples. For this implementation of the objective optics 288, the NA has been determined to be 0.16, and the magnification is 439.8. However, the NA can be larger for alternative embodiments. Since the magnification is coupled with the NA specification, a higher NA means a correspondingly high magnification. The magnification specification depends on the pixel size of the sensor type that is being implemented in the inspection system. In another embodiment with an NA in the 0.14 to 0.18 range, the magnification has a range of 300 to 1,000×.

The field of view specification is typically selected to achieve relative short inspection times (e.g., less than a few hours). In certain implementations, the field of view achieved by the objective is at least 10,000 square microns (μm²) in area, and more specifically at least 100,000 μm². For instance, the field of view can be between 10,000 μm² and 250,000 μm². For the embodiment of FIG. 2, the size of the field of view can be 310 microns by 440 microns (136,000 square microns in area).

Image quality specifications are met by the objective embodiments of the present invention. For instance, wavefront error is kept to less than or equal to about 100 milliwaves (mW) over the designated field of view. Certain implementations of the objective described herein achieve a wavefront error of less than 65 mW and even less than 20 mW. Similarly, distortion is minimized so as to result in minimum image degradation. Certain embodiments of the present invention achieve a target blur that is less than a quarter of the diffraction limited point spread function.

Certain embodiments achieve lens roughness that is below 150 picometers. Surface roughness can be more easily minimized in spherical mirrors and larger aspherical mirrors, as compared with smaller aspheric mirrors. Since the smaller mirrors are spherical, roughness can be reduced to achieve acceptable imaging performance.

The working distance is the distance between the target substrate 106 and the nearest optical element (in this case, the M2 mirror 204). A working distance is selected to provide sufficient space for illumination of the target substrate 106 and mounting of the nearest optical element (e.g., M2 mirror 204). In general example, the working distance is at least 100 millimeters (mm). In the illustrated embodiment of FIG. 2, the working distance from the curved surface is about 153 mm so as to leave room for the substrate thickness of M2 and its mounting hardware.

The total track may be defined as the distance from the target substrate 106 to the sensor 110. In general, the total track size is limited by available clean room space in which the tool is to be placed. For example, the total track may be limited to a size that is below about 1.5 m to ensure that there is enough space for a reasonable tool platform design. In this particular embodiment, the total track is about 1043 mm.

FIG. 3 is an optical ray diagram of a mirror distribution 388 for reflective objective optics in accordance with a second embodiment of the invention. In this embodiment, M1, M2, M3, and M4 mirrors (302, 304, 306, and 308) are arranged such that the patterned light 126 reflects from the M1, M2, M3, and M4 mirrors (302, 304, 306, and 308, respectively) in that order. In this arrangement, the M1 mirror 302 is concave, the M2 mirror 304 is concave, the M3 mirror 306 is convex, the M4 mirror 308 is concave. Hence, the mirrors are, in order: concave; convex; concave; and convex.

An optical prescription for the objective optics 388 in FIG. 3 is provided below in the following Table 2, which has a similar format as Table 1.

TABLE 2
Second Embodiment

| Surface Description | | | | Thickness | Aperture Description | | | |
|---|---|---|---|---|---|---|---|---|
| Elt. | Radius | | | Or | Dimension | | | |
| No. | X | Y | Shape | Separation | X | Y | Shape | Mat'l. |
| Object | Inf. | | FLT | 0.0000 | | | | |
| | | | | 283.5496 | | | CIR | |
| | | | | 322.6656 | 91.920 | | CIR | (Stop) |
| 1 | −502.333 | CC | A-1 | −452.0348 | 200 | 200 | CIR | REFL |
| 2 | 44.919 | CC | SPH | 689.7907 | 16 | 16 | CIR | REFL |
| 3 | 48.632 | CX | SPH | −421.2224 | 16 | 16 | CIR | REFL |
| 4 | 1011.424 | CC | SPH | 496.2224 | 180 | 140 | RECT | REFL |
| | | | | 0.0000 | | | | |

| | | |
|---|---|---|
| IMAGE | Inf. | FLT |

The second embodiment also has the following summarized characteristics:

| Field size | 300 μm × 250 μm | |
|---|---|---|
| Field offset | 195 | μm |
| NA | 0.16 | |
| Aperture decenter | −45 | mm |

In this second embodiment, the M1 mirror 302 has an aspherical surface, while the other M2˜M4 mirrors have spherical surfaces. The following values may be used for the aspheric constants of this M1 mirror 302:
c=−0.199071×10⁻²
k=0.0000000
A=3.93013×10⁻¹¹
B=1.51809×10⁻¹⁶
C=6.35652×10⁻²²
D=−1.99355×10⁻²⁷
E=9.70393×10⁻³²
F=−7.27052×10⁻³⁷
G=0.00000
H=0.00000
J=0.00000

In this embodiment, the second mirror 304 partially obscures the first mirror 302 from the patterned light 126. In other words, part of the area of the first mirror 302 is blocked by the second mirror 304 from receiving the light 126 reflected from the target substrate 106. Furthermore, an opening in the first mirror 302 is used to let the light reflected by the second mirror 304 pass through to reach the third mirror 306.

For this implementation of the objective optics 388, the numerical aperture has been determined to be 0.16, and the size of the field of view has been determined to be 270 microns by 440 microns (118,800 square microns in area). The magnification is 450.6. In this embodiment, the working distance is about 154 mm and the total track is about 919 mm.

Certain embodiments of the present invention enable the objective system to be manufactured with a significantly lower cost since there is only a single aspherical mirror. This low cost is achieved while maintaining moderate performance specifications, including a relatively large field size to allow rapid inspection, an NA and magnification for a low node requirement, reduced levels of wavefront error and distortion, and limits on size.

The embodiments described herein can be designed based on various factors and constraints with some of the constraints being dependent on each other. In one example, the light source is a factor that affects the overall objective design. For example, light sources with significant spectral brightness in the neighborhood of 13 nm are sometimes based on pulsed plasmas, with temperatures in the range 20-50 eV. Due to poor conversion efficiency (conversion from input energy to in-band radiation), such plasma sources show limited brightness at 13-14 nm, and raising the brightness significantly can drive source cost (and thus inspection costs imposed on the mask during fabrication) to levels which impair the economic attractiveness of EUV Lithography (EUVL).

High-throughput operation of mask inspection systems with low brightness plasma sources (discharge or laser produced) drives the need for large object field and detector array, to increase the rate of instantaneous image signal integration and conversion to digital representation.

Simultaneously, to discriminate defect signals from background image noise, the imaging optics can be designed to maximize the collection of light diffracted or scattered by patterning or multilayer defects residing on the EUV mask of interest. For most defects of interest, which diffract and scatter the incident light over a wide range of angles, increasing the NA of the objective will provide an increase in defect signals.

Multilayer-mirror based imaging systems also generally have poor transmission of light, due to the limited reflectivity of multilayers at the design wavelengths near 13-14 nm. A single MoSi multilayer mirror shows peak spectral reflectivity near 13.5 nm in the range of 60-70%. After multiple reflections from near-normal incidence mirrors in typical illumination and imaging optics in an EUV system, system transmission can fall below 1%.

To perform the inspection task adequately, an inspection system can be configured to provide that the light reaching the image plane, which is also converted to digital signals by the detector array, from each resolved region of the mask, reaches a certain number of primary (13 nm) quanta, and so a certain minimum signal-to-noise ratio, which can be a strong function of the number of primary quanta (photons absorbed in the detector material, typically silicon). To compensate for losses in the optical system, while keeping the light incident on the detector constant, the source brightness can be increased, which is difficult to develop and expensive to produce using currently known source technologies.

Alternatively, the range of angles emitted by the source that are transferred to the mask by the illumination optics can be increased, since the amount of light will increase with this angular range, at least within a range of angles supported by the source brightness. In other words, the illumination pupil size can be increased until a physical constraint intervenes. Rigorous studies of defect SNR in inspection optic designs have indicated that for EUV masks, such largely incoherent imaging often provides higher SNR than lower sigma, more coherent operation of the design and system, when used with plasma sources of limited brightness.

The use of beam splitters in reflective imaging systems used in conjunction with reflective objects (such as EUV mask inspection using EUV light) can simplify optical design and layout, by allowing interpenetration or overlap of illumination and imaging pupils in angle space. Current EUV beam splitter technology have low reflection and transmission coefficients (25-35%). Inspection systems can be designed to increase source brightness greatly to compensate for the loss of light reaching the detector caused by the beam splitters. Inspection optics without a beam splitter element is, thus, preferred although embodiments of the present invention that utilize a beam splitter elements are also contemplated.

Light at wavelengths within the spectral bandpass of the resonantly-reflecting multilayer incident on such a uniform (unpatterned) mirror is reflected at 60-70% only if the angle of incidence resides within the angular bandpass as well. Periodic MoSi multilayers have an angular bandpass of 20-25 degrees at 13.5 nm. Light incident outside of the angular bandpass is reflected by the multilayer at very low levels, and, thus, is largely absorbed, or wasted.

Rigorous studies of light propagation and diffraction by patterns on EUV masks indicates that this trend holds for light incident on patterned masks, as well. Furthermore, the angular distribution of light diffracted and scattered by defects present on or in the EUV patterned mask is also modulated by the angular bandpass of the multilayer. The angular distribution of light scattered by a defect depends as well on the defect geometry, and the geometry of the local pattern, and can be significantly skewed to one side of the imaging pupil or another. To collect adequate light from all defect types and for arbitrary pattern geometries, the size of the imaging pupil is typically maximized. Consequently, design of inspection optics without a beam splitter and which operate largely within the finite angular bandwidth of the mask, and which utilize plasma sources of limited brightness, contends with competing angular requirements of the illumination and imaging pupils, each of which seek to maximize the size of their angular extent.

Although increasing the number of mirrors in an imaging design can provide design capability that enables simultaneous high NA and wide object field, this arrangement can lead to a prohibitive decrease in light reaching the detector. Thus, there is significant value in discovering designs that provide adequate inspection performance at minimum mirror count, which do not use a beam splitter, and which balance the competing needs of illuminating and imaging pupils sizes and locations, and thereby enable the production use of low brightness plasma-based EUV sources.

Furthermore, it is of strong economic interest to discover optical designs which provide adequate defect inspection performance for at least two technology nodes, for example 16HP and 11 HP. As the critical defect size that limits chip yield shrinks with technology node, the NA of the inspection system can be increased to compensate for the reduction in scattered light.

During inspection of patterned masks, acquisition and subsequent signal processing of the signal corresponding to a localized defective pattern can be accomplished by comparing or differencing the digital images from a test region of a pattern and a reference region, whether acquired or synthesized from prior information. Such difference operation removes the pattern, leaving the defect as a perturbation of a quasi-uniform background signal.

Imaging pupils are often circularly symmetric, leading to symmetric point spread functions at the image plane. While such symmetry is often required in lithography, mask inspection via difference imaging does not require symmetric psf (point spread function), and, consequently, the imaging pupil can afford to be asymmetric.

In particular, obscuration of a portion of the imaging pupil can be tolerated, if defect signal collection is not compromised significantly.

Additionally, the shape of the parent pupil need not be circular. For instance, square or rectangular shapes for the parent are possible, and even advantageous when considering the incremental gain of scattered defect light or signal through addition of pupil region.

Expressed as a fraction of pupil area, obscuration fractions less than 5 or 10% are preferred. Obscuration in 4-mirror designs is often created through the blocking or shadowing of light reflected or scattered from the mask by the second mirror, or M2 as described above. Minimizing the size of both reflecting surface and peripheral support of M2 will minimize obscuration.

The design of structural support for M2 provides for sufficient rigidity, so that environmental disturbances or vibrations do not drive or lead to dynamic perturbations of M2 position and, thus, to degradation of image quality through blurring.

Since mirrors for EUV light are coated with multilayers to reach adequate reflectivity, the range of incidence angles on any of the highly curved elements is also considered, and restricted within the limits of multilayer deposition process technology. When estimating the defect SNR of a particular objective and system design, the apodization or modulation of transmission of each light ray by local reflectivity variations at the point of reflection on each mirror induced by the multilayer deposition process must be considered.

In particular, the design process includes balancing obscuration, structural response and curvature factors in the geometry of the second mirror or M2, in order to secure the minimum viable defect SNR which enables fast and economic mask inspection.

The choice of chief ray in design of the objective for mask inspection also balances several competing factors. The chief ray is defined by the centroid of the angular distribution of light rays transmitted by the objective to the image plane with due consideration of the pupil apodization caused by mirror coatings. Although conventional designs for reflective imaging without a beamsplitter place the plane dividing the illumination and collection light bundles on the optical axis and coincident with the object surface normal, inspection oriented optics do not demand or strongly prefer this choice. Thus allowing placement of the lower marginal ray of the imaging pupil below the surface normal is found to be advantageous for defect signal collection.

Correspondingly, in the process of increasing defect SNR, as the NA is increased from low levels, in higher performance designs the imaging chief ray (relative to the surface normal) is below the numerical value of the NA. Inspection-optimized EUV objective designs bias the imaging chief rays toward the surface normal to maximize overlap of imaging pupil with multi-layer modulated angular distribution of light scattered by pattern defects, while providing sufficient angular range (still largely restricted to the multilayer angular bandpass) to the illumination pupil to secure adequate photon flux from the limited brightness plasma EUV sources.

It should be noted that the above diagrams and description are not to be construed as a limitation on the specific components of the system and that the system may be embodied in many other forms. For example, it is contemplated that the inspection or measurement tool may be any of a number of suitable and known imaging or metrology tools arranged for resolving the critical aspects of features of a reticle or wafer. By way of example, an inspection or measurement tool may be adapted for bright field imaging microscopy, darkfield imaging microscopy, full sky imaging microscopy, phase contrast microscopy, polarization contrast microscopy, and coherence probe microscopy. It is also contemplated that single and multiple image methods may be used in order to capture images of the target. These methods include, for example, single grab, double grab, single grab coherence probe microscopy (CPM) and double grab CPM methods. Non-imaging optical methods, such as scatterometry, may be contemplated.

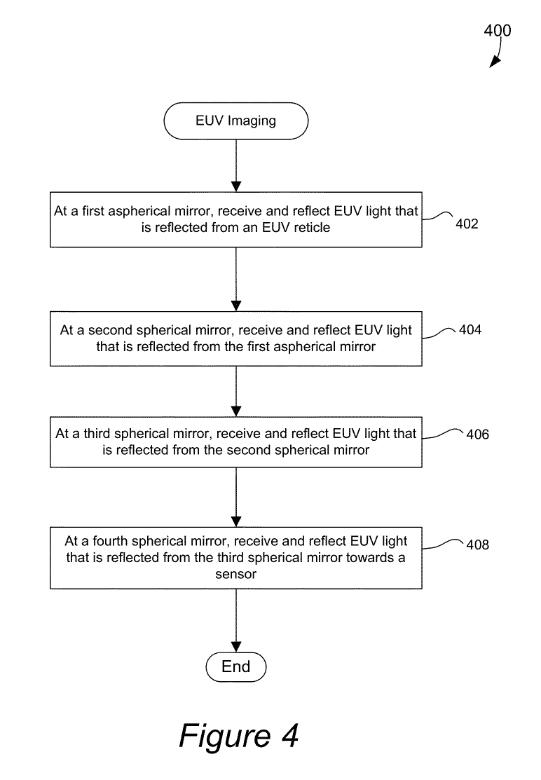

The above described objective systems can be used to reflect EUV light from an EUV reticle towards a sensor. FIG. 4 is a flow chart illustrating such a imaging process (400) in accordance with one embodiment of the present invention. Initially, EUV light that is reflected from an EUV reticle is received and reflected at a first aspherical mirror in operation 402. EUV light that is reflected from the first mirror is then received and reflected at a second spherical mirror in operation 404. EUV light that is reflected from the second mirror is then received and reflected at a third spherical mirror in operation 406. EUV light that is reflected from the third mirror is then received and reflected at a fourth spherical mirror towards a sensor in operation 406.

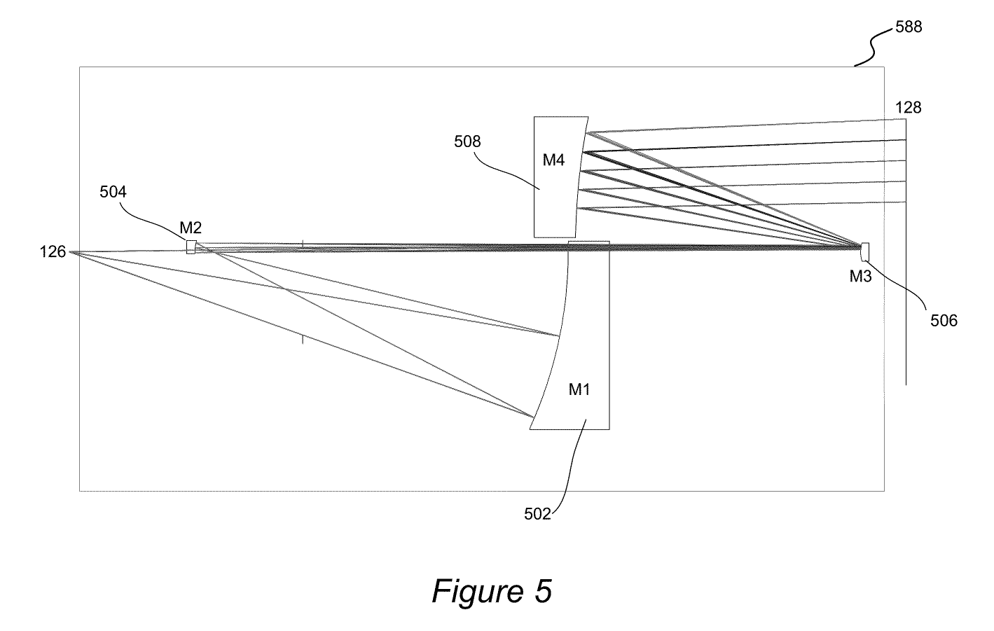

In yet another embodiment, FIG. 5 is an optical ray diagram of a mirror distribution 588 for the objective optics of FIG. 1 in accordance with a third embodiment of the invention. In this embodiment, M1, M2, M3, and M4 mirrors (502, 504, 506, and 508) are arranged such that the patterned light 126 reflects from the M1, M2, M3, and M4 mirrors (502, 504, 506, and 508, respectively) in that order. In this arrangement, the M1 mirror 502 is concave, the M2 mirror 504 is concave, the M3 mirror 506 is convex, the M4 mirror 508 is concave. Hence, the mirrors are, in order: concave; convex; concave; and convex.

An optical prescription for the objective optics 588 in FIG. 5 is provided below in the following Table 3, which has a similar format as Table 1.

TABLE 3
Third Embodiment

| Surface Description | | | | Thickness | Aperture Description | | | |
|---|---|---|---|---|---|---|---|---|
| Elt. | Radius | | | Or | Dimension | | | |
| No. | X | Y | Shape | Separation | X | Y | Shape | Mat'l. |
| Object | Inf. | | FLT | 0.0000 | | | | |
| | | | | 282.983 | | | CIR | |
| | | | | 322.0416 | 103.565 | | CIR | (Stop) |
| 1 | −502.162 | CC | A-1 | −452.7088 | 220 | 220 | CIR | REFL |
| 2 | 45.733 | CC | SPH | 807.5429 | 14 | 14 | CIR | REFL |
| 3 | 42.025 | CX | SPH | −346.1394 | 20 | 20 | CIR | REFL |
| 4 | 846.541 | CC | SPH | 401.1394 | 220 | 140 | CIR | REFL |
| | | | | 0.0000 | | | CIR | |

| | | |
|---|---|---|
| IMAGE | Inf. | FLT |

The third embodiment also has the following summarized characteristics:

| Field size | 440 μm × 200 μm | |
|---|---|---|
| Field offset | 220 | μm |
| NA | 0.18 | |
| Aperture decenter | −40 | mm |

In this third embodiment, the M1 mirror 502 has an aspherical surface, while the other M2˜M4 mirrors have spherical surfaces. The following values may be used for the aspheric constants of this M1 mirror 502:
c=−1.991390×10⁻²
k=0.0000000
A=3.903650×10⁻¹¹
B=1.513180×10⁻¹⁶
C=5.981350×10⁻²²
D=−8.406120×10⁻²⁸
E=8.163200×10⁻³²
F=−6.73780×10⁻³⁷
G=0.00000
H=0.00000
J=0.00000

In this embodiment, the second mirror 504 partially obscures the first mirror 502 from the patterned light 126. In other words, part of the area of the first mirror 502 is blocked by the second mirror 504 from receiving the light 126 reflected from the target substrate 106. Furthermore, an opening in the first mirror 502 is used to let the light reflected by the second mirror 504 pass through to reach the third mirror 506.

Although the foregoing invention has been described in some detail for purposes of clarity of understanding, it will be apparent that certain changes and modifications may be practiced within the scope of the appended claims. It should be noted that there are many alternative ways of implementing the processes, systems, and apparatus of the present invention. For example, the objective system embodiments described above can be utilized in any suitable system for imaging EUV light from any object, besides reticles.

Accordingly, the present embodiments are to be considered as illustrative and not restrictive, and the invention is not to be limited to the details given herein.

What is claimed is:

1. An apparatus for reflecting, towards a sensor, extreme ultra-violet (EUV) light that is reflected from a target substrate, the apparatus comprising:
an illumination source for generating EUV light that illuminates a target substrate;
objective optics for receiving and reflecting EUV light that is reflected from the target substrate; and
a sensor for detecting EUV light that is reflected by the objective optics,
wherein the objective optics comprises
a first mirror arranged to receive and reflect EUV light that is reflected from the target substrate,
a second mirror arranged to receive and reflect EUV light that is reflected by the first mirror,
a third mirror arranged to receive and reflect EUV light that is reflected by the second mirror, and
a fourth mirror arranged to receive and reflect EUV light that is reflected by the third mirror,
wherein the first mirror has an aspherical surface, and wherein the second, third, and fourth mirrors each has a spherical surface.

2. The apparatus of claim 1, wherein the target substrate is an EUV photolithography mask.

3. The apparatus of claim 1, wherein the first and fourth mirrors each have a size that is equal to or greater than about 200 mm, and wherein the second and third mirrors each have a size that is less than or equal to about 50 mm.

4. The apparatus of claim 1, wherein the second mirror partially obscures the first mirror from EUV light that is reflected from the target substrate, and wherein the first mirror includes an opening through which the EUV light that is reflected from the second mirror passes and is received by the third mirror.

5. The apparatus of claim 1, wherein a numerical aperture (NA) of the objective optics is equal to or lower than 0.20.

6. The apparatus of claim 5, wherein a numerical aperture (NA) of the objective optics is between about 0.14 and 0.18.

7. The apparatus of claim 6, wherein a magnification of the objective optics has a range between about 300× and 1000×.

8. The apparatus of claim 1, wherein a field of view of the objective optics is at least 10,000 square microns.

9. The apparatus of claim 1, wherein a field of view of the objective optics is at least 100,000 square microns.

10. The apparatus of claim 1, wherein the objective optics are associated with a wavefront error that is less than or equal to about 100 milliwaves.

11. The apparatus of claim 10, wherein the objective optics are associated with a wavefront error that is less than or equal to about 20 milliwaves.

12. The apparatus of claim 10, wherein the objective optics are associated with a target blur of an image of an object of the target substrate that is less than a quarter of a diffraction limited point spread function.

13. The apparatus of claim 1, wherein the objective optics has a working distance that is at least 100 mm.

14. The apparatus of claim 1, wherein the objective optics is sized to have a total track distance from the target substrate to the sensor that is less than about 1.5 m.

15. An objective optics system for reflecting extreme ultra-violet (EUV) light that is reflected from a target substrate, the system comprises:
a first mirror arranged to receive and reflect EUV light that is reflected from the target substrate,
a second mirror arranged to receive and reflect EUV light that is reflected by the first mirror,
a third mirror arranged to receive and reflect EUV light that is reflected by the second mirror, and
a fourth mirror arranged to receive and reflect EUV light that is reflected by the third mirror,
wherein the first mirror has an aspherical surface, wherein the second, third, and fourth mirrors each have a spherical surface.

16. The system of claim 15, wherein a numerical aperture (NA) of the objective optics system is equal to or less than 0.20.

17. The system of claim 15, wherein a field of view of the objective optics system is at least 10,000 square microns.

18. The system of claim 15, wherein the objective optics system is associated with a wavefront error that is less than or equal to about 100 milliwaves.

19. The system of claim 15, wherein the objective optics system has a working distance that is at least 100 mm.

20. A method of reflecting extreme-ultraviolet (EUV) light that is reflected from an EUV reticle towards a sensor, comprising:
at a first aspherical mirror, receiving and reflecting EUV light that is reflected from the EUV reticle;
at a second spherical mirror, receiving and reflecting EUV light that is reflected from the first aspherical mirror;
at a third spherical mirror, receiving and reflecting EUV light that is reflected from the second spherical mirror; and
at a fourth spherical mirror, receiving and reflecting EUV light that is reflected from the third spherical mirror towards the sensor.
